(19) United States
(12) Patent Application Publication
(10) Pub. No.: US 2006/0242040 A1
(43) Pub. Date: Oct. 26, 2006

(54) Method and system for conducting sentiment analysis for securities research

(75) Inventor: Jeffrey Scott Rader, Vandalia, OH (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: AIM HOLDINGS LLC, Dayton, OH (US)

(21) Appl. No.: 11/110,291

(22) Filed: Apr. 20, 2005

(51) Int. Cl. G06Q 40/00

(52) U.S. Cl. 705/35

(57) ABSTRACT

A computer system performs financial analysis on one or more financial entities, which may be corporations, securities, etc., based on the sentiment expressed about the one or more financial entities within raw textual data stored in one or more electronic data sources containing information or text related to one or more financial entities. The computer system includes a content mining search agent that identifies one or more words or phrases within raw textual data in the data sources using natural language processing to identify relevant raw textual data related to the one or more financial entities, a sentiment analyzer that analyzes the relevant raw textual data to determine the nature or the strength of the sentiment expressed about the one or more financial entities within the relevant raw textual data and that assigns a value to the nature or strength of the sentiment expressed about the one or more financial entities within the relevant raw textual data, and a user interface program that controls the content mining search agent and the sentiment analyzer and that displays, to a user, the values of the nature or strength of the sentiment expressed about the one or more financial entities within the data sources. This computer system enables a user to make better decisions regarding whether or not to purchase or invest in the one or more financial entities.

### FIELD OF TECHNOLOGY

This patent relates generally to financial analysis of securities information and, more specifically, to the use of automated sentiment analysis in securities research.

### BACKGROUND

The widespread adoption of networked computers by users in the United States and worldwide has promoted an exponential increase in the volume of news, commentary, and opinion generated by sources available from a common computer network, like the Internet. The increased use of networked computers has also resulted in an increase in available data about publicly traded companies. Investors seeking information about public entities traditionally gather the majority of their data from financial publications and documents filed by a company with the Securities Exchange Commission, which sources typically contain financial data including revenues, earnings per share, price-earnings ratios, cash flows, dividend yields, product launches and company management strategies. The price performance of a company's stock will often be heavily dependent upon the company's financial results. Additionally, many investors rely on a stock's historical pricing and volume to identify trends and to attempt to predict future behavior of the stock. Financial analysts offer reports for many publicly traded corporations which use a variety of methods to condense the above information into a summary to assist investors with their decision-making. However, there is currently no automated method available for reviewing and organizing the rapidly growing content available on Internet message boards, chat rooms, and financial websites.

The enormous growth of available information has resulted in an environment that is rapidly changing and that can, in some cases, involve millions of pages of relevant online content. While much of this content has real value to an investor interested in conducting research on a company's stock, it is increasingly difficult for any single investor to comprehensively retrieve all of the available data on any single company and to process this data in an effective and timely manner. This situation is unfortunate, as the stock-related information expressed in the opinions and feedback available on the Internet can often be correlated to changes in the prices of stocks, thereby being valuable to those interested in stock research.

One method of monitoring and analyzing online content is called sentiment analysis. One known method of sentiment analysis begins by identifying preferred websites, public databases, newsgroups, message boards or chat rooms. Once the preferred sources are identified, they are searched for relevant discussions of a topic requested by a user. The sentiment analyzer then uses natural language technology to interpret the general sentiment or opinion expressed in the text regarding the identified topic. Language technology identifies key words, determines the nature of the sentiment expressed in the text, and then categorizes the data into meaningful categories. The results are then analyzed to provide the user with a gauge of the overall positive or negative impression of the topic. This sentiment analysis process has been used in the consumer goods industry to retrieve and analyze consumer feedback for specific goods and services. For example, by reviewing opinions expressed by consumers about its company and products, a corporation can use sentiment analysis information to improve its corporate strategy, product development, marketing, sales, customer service, etc.

### SUMMARY OF THE DISCLOSURE

The application of sentiment analysis to financial data would significantly increase an investor's ability to review and track opinion information about securities. Armed with both up-to-date and historical opinion data, the investor would be able to make a more-informed decision regarding the purchase and sale of securities. In that regard, a financial analysis system disclosed herein uses sentiment analysis to gather and analyze data about a company or other entity, resulting in an overall summary of opinions expressed in a number of electronic sources, such as individual postings on message boards, chat rooms, and more traditional financial news sources to aid an investor or other user in analyzing the performance of a company, stock or security. The disclosed financial analysis system also provides the ability to track trends in sentiment readings over time.

In one embodiment, the disclosed financial analysis system is an Internet-based tool that incorporates a number of technologies, the combined effect of which is to provide users with a powerful, online tool for quickly evaluating the level and trending of the sentiment of online postings related to a particular company. The Internet-based tool may include a content mining search agent, a specially trained sentiment analyzer, an archive database of mined data and a user interface program that allows a user to conduct direct searches and to view results. Each of these elements may be housed on a server connected to the Internet so that users may access the financial analysis system through the Internet and so that the system may easily access data to be analyzed located primarily on the Internet.

During operation, the content mining search agent reviews text obtained from one or more information sources and identifies content relevant to one or more individual stocks or other securities. The content mining search agent may perform these services on a pre-selected set of sources of useful information for securities, and if desired, these sources may be categorized into subsets, from which a user may select. In addition, or alternatively, the user may be given the opportunity to identify particular sources to be mined.

The text gathered by the content mining search agent is analyzed by a natural language sentiment analyzer. Where possible, the sentiment analyzer discerns the topic of the content and assigns either a positive or a negative sentiment bias to each piece of information, depending on whether the attitude or opinion expressed in the piece of information is favorable or unfavorable to the company or to a topic relating to the company. The positive or negative value may be marked with a date, categorized by the topic of the information discussed, and stored in a portion of an archive database assigned to a particular feature of the company (e.g., the quality of management at the company). The data gathered from the content mining search agent and the results of the sentiment analyzer may be stored in an archive database located on a central server.

The user interface program which may also be located on the central server, generally controls the financial analysis system by directing the content mining search agent and sentiment analyzer to conduct searches and perform sentiment analysis as directed by a user and to display the results of the searches and analysis to the user. These searches may be performed at periodic intervals or at the request of a user or an operator.

For example, a user accessing the financial analysis system through the Internet uses a display generated by the user interface program to select a topic about which sentiment data is desired. The user interface program may then send a request to the database archive, which retrieves data relevant to the requested topic that has been previously located and stored in the database. Alternatively, the user interface program may prompt the content mining search agent to conduct an on-line search of data sources having data pertaining to the requested topic. In either case, the sentiment analyzer may analyze the located data to determine the expressed sentiment regarding the selected topic within the data source or data sources. The user interface program then creates an aggregate value corresponding to the overall sentiment expressed for the selected topic and generates a graphical representation of the sentiment analysis containing the user's requested results. This graphical representation may contain sentiment analysis results for each source selected in the query, along with stock pricing and analyst rankings corresponding in time to the sentiment analysis, allowing a user to make informed stock purchase and sale decisions incorporating traditionally available information and online sentiment information.

### BRIEF DESCRIPTION OF THE DRAWINGS

FIG. 1 illustrates a schematic diagram demonstrating the use of a content mining search agent and sentiment analyzer to retrieve and evaluate online content relating to securities.

FIG. 2 depicts a flow chart outlining steps performed by a user interface program that controls a financial analysis system to gather data to be stored in an archive database.

FIG. 3 depicts a flow chart illustrating the flow of data when a financial analysis is conducted by the financial analysis system of FIG. 1.

FIG. 4 illustrates a sample display that may be used to select a security for which a request for information is desired.

FIG. 5 illustrates a sample display that may be used to identify a topic and to run a query for an identified security.

FIG. 6 illustrates a sample graphical output generated by the financial analysis system of FIG. 1 depicting the results of a sentiment analysis conducted on a selected corporation using a single data source.

FIG. 7 illustrates a sample graphical output generated by the financial analysis system of FIG. 1 depicting the results of sentiment analysis conducted on a selected corporation using multiple data sources.

FIG. 8 illustrates a sample graphical output generated by the financial analysis system of FIG. 1 depicting the results of a sentiment analysis conducted on a selected corporation using data from multiple sources, along with the historical stock price for the selected corporation.

FIG. 9 illustrates a sample output generated by the financial analysis system of FIG. 1 depicting the results of a sentiment analysis conducted on a selected corporation using data from multiple sources, along with historical stock prices for the selected corporation and a consensus of Wall Street analyst reports.

### DETAILED DESCRIPTION

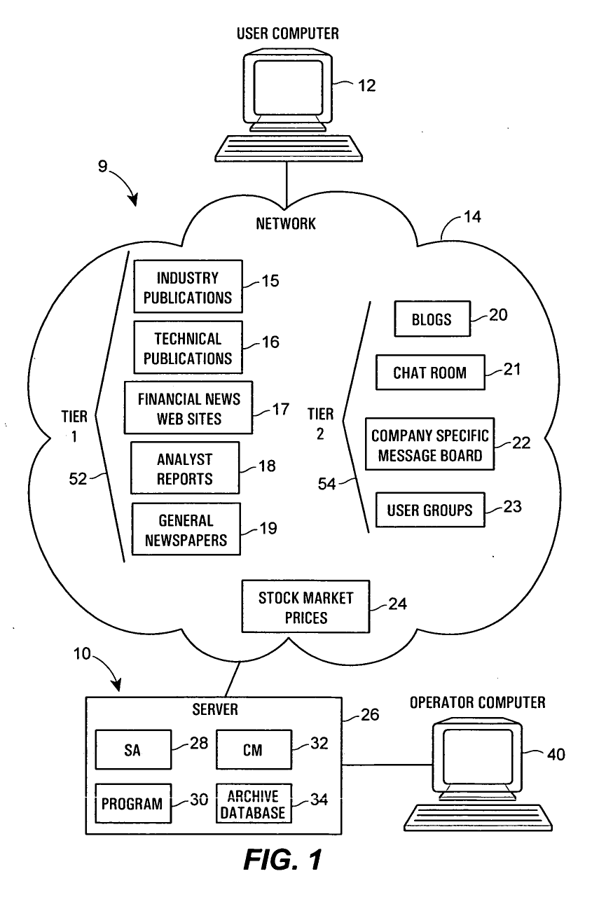

FIG. 1 illustrates a computer system 9 on which a financial analysis system 10 is implemented. The computer system 9 includes a user computer 12 connected to a network of computers 14 and to the financial analysis system 10, which may be in the form of a server 26 communicatively connected to an operator computer 40. Generally speaking, the computers (12, 40) are processing and input/output devices that are connected to the computer network 14 and to the server 26. In one embodiment, the computers within the computer network 14 may be communicatively connected together via the Internet, which forms the network 14. Alternatively or in addition, the network 14 may be made up of computers interconnected via private or secured communication connections, public connections such as telephone, cable, wireless or fiber optic communication connections, and the network 14 may include any number or type of local area networks (LANs) or wide area networks (WANs).

A user, working from the user computer 12, may access and retrieve information from the server 26, either directly, or through the network of computers 14. Likewise, an operator may access the financial analysis system 10 through the computer 40 connected to the server 26 either directly, or through a network. In one embodiment, sources of information to be analyzed or used by the financial analysis system 10 are located in the network of computers 14 which may be in the form of the Internet, in which case these sources may include, for example, industry publications 15, technical publications 16, financial news web sites 17, analyst reports 18, general newspapers or news websites 19, Internet blogs 20, chat rooms 21, company specific message boards 22, etc.

As illustrated in FIG. 1, the server 26 may include a sentiment analyzer 28, a user interface program 30, a content mining search engine 32 and an archive database 34. Generally speaking, the user interface program 30 enables a user, such as a user at the computer 12, to perform sentiment analysis on data stored within some subset of the data sources available on the network 14 and to obtain the results of such sentiment analysis at the computer 12, to thereby assist the user in analyzing a company, a security or other financial product for the purpose of making decisions regarding investing in that company, security or financial product. During operation of this sentiment analysis procedure, the content mining search agent 32 identifies relevant text contained in one or more of the sources 15-23. Thereafter, the sentiment analyzer 28 categorizes the identified text, evaluates the sentiment expressed in the categorized text and assigns some value or identifier expressing the positivity or negativity of the expressed sentiment. This value, along with other data including, for example, the raw data or information obtained from the sources 15-23, the identity of the sources from which data is obtained, current stock price data, etc., may be stored in the database archive 34 and may be provided to the user via the computer 12. If desired, the sentiment analyzer 28 may periodically evaluate the sentiment in a given set of data sources to provide the user with a tend of sentiment over time. Thus, the user interface program 30 allows a user to initiate a query regarding a particular security or topic and directs the activities of the sentiment analyzer 28 and content mining search agent 32 to implement a search for and an analysis of the data sources available via the network 14 related to that security and topic. During this process, the user interface program 30 may communicate with the user computer 12 and the data sources over the Internet or using any other desired communication connection(s).

Currently, the most commonly employed method of transferring data over the Internet is to employ the World Wide Web environment, also called simply “the web”. While other Internet resources exist for transferring information, such as File Transfer Protocol (FTP) and Gopher, these resources have not achieved the popularity of the web. In the web environment, servers and clients affect data transaction using the Hypertext Transfer Protocol (HTTP), a known protocol for handling the transfer of various data files (e.g., text, still graphic images, audio, motion video, etc.) Information is formatted for presentation to a user by a standard page description language, the Hypertext Markup Language (HTML). In addition to basic presentation formatting, HTML allows developers to specify “links” to other web resources identified by a Uniform Resource Locator (URL), which is a special syntax identifier defining a communications path to specific information. Each logical block of information accessible to a client, called a “page” or a “web page”, is identified by a URL. The URL thus provides a universal, consistent method for finding and accessing this information by the web “browser”, which is a program capable of submitting a request for information identified by a URL at the client machine. Retrieval of information on the web is generally accomplished with an HTML-compatible browser.

In one embodiment of the financial analysis system 10, the user computer 12 may access, via the Internet, a web home page stored on the server 26. Generally, the server 26 is a computer or device on a network that manages network resources, and in one embodiment, may be a central server maintained by the operator of the financial analysis system 10. However, while the embodiment of FIG. 1 demonstrates a single server 26 performing multiple tasks, separate dedicated servers or computers could also be used to perform one or more of these tasks.

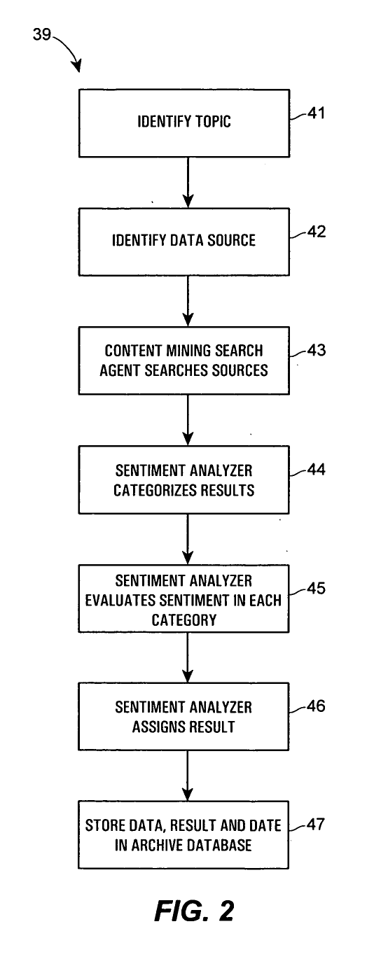

FIG. 2 depicts a flow chart 39 generally outlining steps that may be completed by the different elements of the financial analysis system 10 of FIG. 1 in conducting financial analysis and, in particular, by the user interface program 30 that controls the financial analysis system 10. While the user interface program 30 is described herein as a single computer program that completes all of the tasks described, these or similar tasks may be performed by separate, discrete computer programs working together or independently as desired. Additionally, it may not be necessary for each of the identified tasks to be completed in order to generate the desired result. Thus, the user interface program 30, individually, or in conjunction with other computer programs, completes some or all of the steps identified below.

At a first step 41, the user interface program 30 (which may also be a control program) identifies one or more securities for which sentiment analysis is to be performed. The step 41 may be completed by obtaining direct input from a user or an operator as to the one or more securities, companies or other financial products for which analysis is desired. Alternatively, the user interface program 30 may automatically identify these securities based on, for example, stored search parameters. In one embodiment, the user will be given an option to select stocks from a predetermined collection that may include hundreds, thousands, or even tens of thousands of securities. Additionally, the operator may create the collection of securities based upon some theme, which may include companies selling similar products, companies working in a particular area of technology, geographical location of the security or company, or some other features of the security.

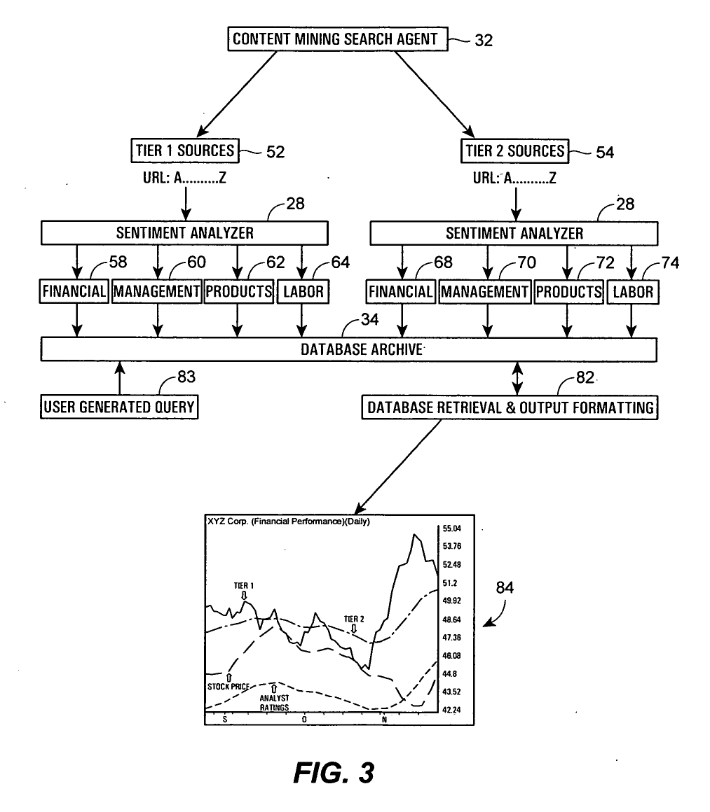

At a step 42, the user interface program 30 identifies sources from which data regarding the identified securities, companies or other financial products is to be retrieved. One manner of identifying data sources is illustrated in more detail in FIG. 3, which will be discussed in more detail later. Generally speaking, however, the user interface program 30 may complete the step 42 automatically based upon pre-selected criteria, using a browser or other search engine that searches for relevant data sources, or by obtaining data or indications of sources from a user or an operator. In an embodiment in which all of the data sources 15-23 are accessible via the Internet, the indication of a source may be in the form of one or more URLs associated with each data source. However, other types of indications may be used as well.

At a step 43, the user interface program 30 directs the content mining search agent 32 to search the identified sources for text or data related to the securities, companies or other financial product for which an analysis is being performed. If desired, the interface program 30 may automatically and periodically perform the step 43, directing the content mining search agent 32 to retrieve relevant text from predetermined data sources 15-23 at any desired rate or frequency. In one embodiment, the predetermined data sources 15-23 may include hundreds, or even thousands, of websites, as it is expected that a greater number of predetermined data sources 15-23 will result in greater accuracy in measuring the sentiment analysis expressed overall. Alternatively or in addition to automatic retrieval, a user may manually initiate the retrieval of data at any desired time. As will be understood, the content mining search agent 32, which may be any desired or suitable, generally available search engine, may be trained to identify key phrases and words (such as key words and phrases provided by the database owner, the user at the computer 12 or any other authorized user) within the raw text of the searched data sources using natural language processing. If desired, the search agent 32 may retrieve and store the relevant content related to the identified security, company or financial product within the database 34 in addition to or instead of storing an identification of the particular source of that data.

At a step 44, the user interface program 30 directs the sentiment analyzer 28 to categorize the data identified or retrieved by the content mining search agent 32 from the sources 15-23 into one of a number of pre-determined categories, which may include, for example, financial performance, management performance, products and services, and work environment or labor relations. These or other categories to be used may be selected by the user or by the user interface program 30 if so desired. Such categories may be defined by category definition parameters included within the user interface program 30. Of course, other categories may be used and, in many situations, it may not be necessary to categorize the data in any manner prior to performing sentiment analysis on the data.

At a step 45, the sentiment analyzer 28 detects the nature and/or strength of sentiment in the retrieved and categorized text. The sentiment analyzer 28 may also extract specific facts and data points from the reviewed text. It will be understood that any of many available sentiment analyzers may be used to complete the analysis. In particular, commonly available sentiment analyzers include Accenture™'s Sentiment Monitoring Service and Intelliseek™'s BrandPulse Internet™, for exanple. One method for applying sentiment analysis to chat rooms was described in the Journal of Finance in 2004. Werner Antweiler and Murray Z. Frank, “Is All That Talk Just Noise? The Information Content of Internet Stock Message Boards,” Journal of Finance, June 2004, 1259-1294. Of course, other sentiment analyzers could be used instead.

At a step 46, the sentiment analyzer 28 may assign a value corresponding to the expressed sentiment to each piece of information obtained by the content mining search agent 32. The sentiment analyzer 28 may then calculate an aggregate value of sentiment for each topic queried. This aggregate value may be based upon any formula chosen by the user or operator to combine the values assigned to each piece of information, including an average, a weighted average or any other mathematical combination. If desired, the sentiment analyzer 28 may analyze the mined data after it has been separated into one or more categories, and may assign an aggregate value or identifier to each category representing the summary of the opinions expressed in the mined data on a category by category basis. By analyzing separate categories, the financial analysis system 10 further defines attitudes expressed toward each of a number of qualities or characteristics about each security, allowing users to parse and evaluate changes in attitudes toward multiple aspects of a company, each of which may exert a different influence on the stock price for the company. A user may then differentiate the selected analysis by topic or issue. Alternatively, the sentiment analyzer may analyze all mined data for a single corporation, security or other financial product, if the user prefers to receive an overall financial analysis for the entity. If desired, the assigned value may be numerical or may be textual in nature defining, for example, one of a number of pre-determined levels of sentiment. In a step 47, the user interface program 30 may store the assigned value in the database archive 34, marked by the date of collection, for example. While not specifically indicated in FIG. 2, the user interface program 30 may also display the value for a particular category of a financial product, corporation or security to a user. If desired, and as will be explained in more detail below, the user interface program 30 may also provide the user with a display illustrating the change of the sentiment for a particular category of a financial product, corporation or security over time.

FIG. 3 demonstrates the data flow that occurs in one embodiment of the financial analysis system 10 of FIGS. 1 and 2. During a retrieval process in the embodiment depicted in FIG. 3, the content mining search agent 32 connects to the data sources 15-23 through the network 14. In this embodiment, the data sources 15-23 are pre-selected and are categorized into two or more subsets 52 and 54 referred to as Tier 1 and Tier 2 sources, respectively. The sources 52 and 54 may include content generated by a variety of sources, including traditional online publishers 52 (Tier 1 sources) and individual persons 54 (Tier 2 sources). In this embodiment, a user may identify and give varied weight to the separate analysis of content generated by news media (Tier 1) versus content contained in consumer generated media (Tier 2), as it is expected that such sources exert different influences on stock prices. The Tier 1 sources 52 may include, but are not limited to, widely distributed online publications such as industry publications 15, technical publications 16, financial news organization publications 17, analyst reports 18, and general circulation newspapers 19, and are typically viewed as being more authoritative or reliable sources for determining sentiment. On the other hand, the Tier 2 sources 54 may include, but are not limited to, website journals generated by individual users or groups of individuals commonly referred to as weblogs or blogs 20, chat rooms 21, company-specific message boards 22, or user groups 23. The data sources 52 and 54 may be, but are not required to be pre-selected or categorized, but should generally be chosen before a search is conducted.

As illustrated in FIG. 3, the sentiment analyzer 28 reviews the raw text identified by the content mining search agent 32 within the Tier 1 and Tier 2 sources 52 and 54 and sorts that text into, in this example, four discrete categories for each data source 52, 54. As indicated in FIG. 3, these categories of data include financial performance 58, 68, management performance 60, 70, products and services 62, 72, and work environment or labor relations, 64, 74.

Generally speaking, the first category, financial performance 58, 68, is related to the perceived market performance for a specific security. If the text of the data in a source indicates that the analyzed opinions expect the security to be on the rise, such that the financial value of the security is expected to increase, the financial performance sentiment will be perceived as positive or bullish. On the other hand, if the analyzed opinions indicate that the security is expected to be in decline, such that the financial value of the security will likely decrease, the financial performance sentiment will be perceived as negative or bearish. The second category, management performance 60, 70, is related to the sentiment expressed by the mined data with regard to the overall expressed opinion about the company's corporate governance and strategy. This sentiment may be articulated as a positive or a negative value depending upon the opinions expressed. The third category, products or services 62, 72, is related to sentiments expressed regarding the goods offered to the marketplace or the work (services) performed for pay by the corporation associated with the selected security. This sentiment may be articulated as a positive or a negative value depending upon the opinions expressed. Likewise, the fourth category, work environment or labor relations 64, 74, is related to sentiments expressed regarding the interactions between the upper management and the rest of its employees of the corporation or entity associated with the security. This sentiment may be articulated as a positive or negative value depending upon the opinions expressed.

During operation, the sentiment analyzer 28 may evaluate the strength or nature of the sentiment expressed regarding each topic in the categorized text. The sentiment analyzer 28 may then assign a value to this sentiment, and the value of the sentiment is stored, along with the date the search was conducted and, possibly, the selected text retrieved, in the database archive 34.

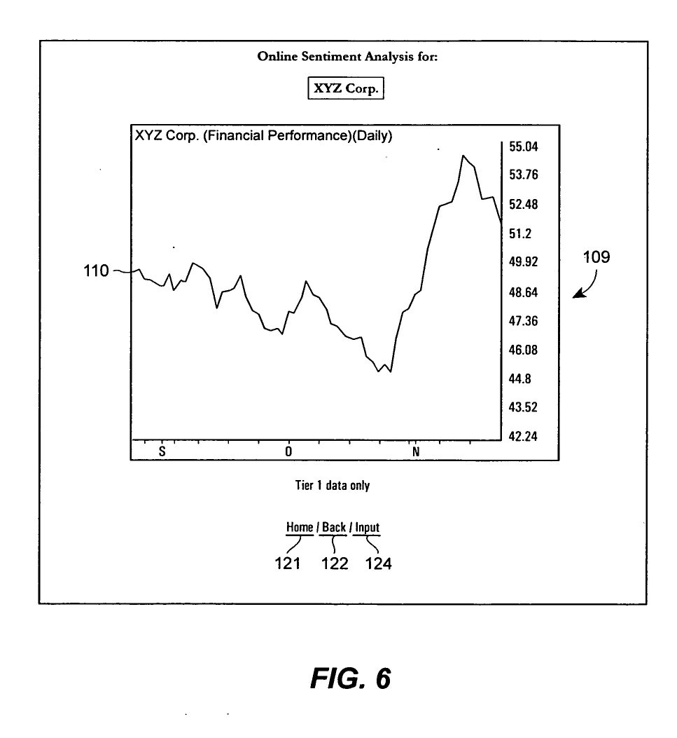

As illustrated below the data archive 34 of FIG. 3, when a user initiates a search, through a user generated query 83, the user interface program 30 may direct the query to the database archive 34 to retrieve stored results relating to the user query 83. On the other hand, if no previous search or analysis of the entity selected by the user has been performed or if the user prefers a contemporaneous sentiment analysis result, the content mining search agent 32 and the sentiment analyzer 28 may operate to locate and analyze relevant data stored within the data sources 15-23 and determine a sentiment as expressed in those data sources. In the circumstance where no previous search has been conducted, the content mining search agent may also locate and search historical data, if available from the data sources 15-23 for analysis by the sentiment analyzer 28. As illustrated by the box 82, the user interface program 30 may then format the data for display and direct that the results be graphically displayed to a user. An example of one possible type of graphical output that may be generated is illustrated in a box 84 in FIG. 3. Further examples of such possible graphical representations are illustrated in FIGS. 6-9, which summarize the historical sentiment analysis for a specific security through a period of time. In these cases, the user may also be given the option to select the period of time for which data will be analyzed and plotted. In one embodiment, the graphical representation output will display historical data for a time period of the most recent three months, with the most current result generated immediately upon user request or based upon the most recent automatic, stored analysis conducted prior to the user's request. If desired, sentiment analysis retrieved from each source of data can be graphed separately, and additional information, including stock price and analyst ratings retrieved from other sources may be separately retrieved and graphed along with the corresponding sentiment analysis. In one embodiment, stock price data 24 and analyst ratings 18 are retrieved via the Internet.

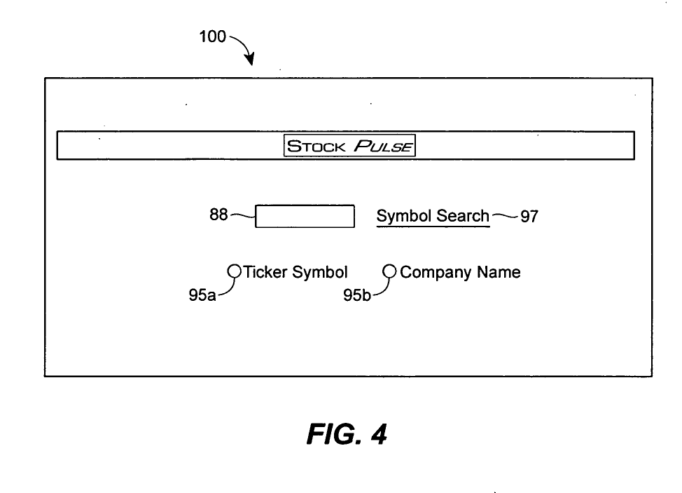

When using the financial analysis system 10 of FIG. 1, a user may access the server 26 through a web home page maintained by the operator of the financial analysis system 10. One example of such a home page 100 is shown in FIG. 4. On this web page, the user may identify a specific company or security for which the user is interested in obtaining an analysis of online sentiment. At, for example, a query box 88, a user may enter a symbol or company name to identify a security or other financial product. The user may indicate if the entered information is a ticker symbol or a company name using the selection boxes 95a and 95b and may perform a symbol search using the link 97.

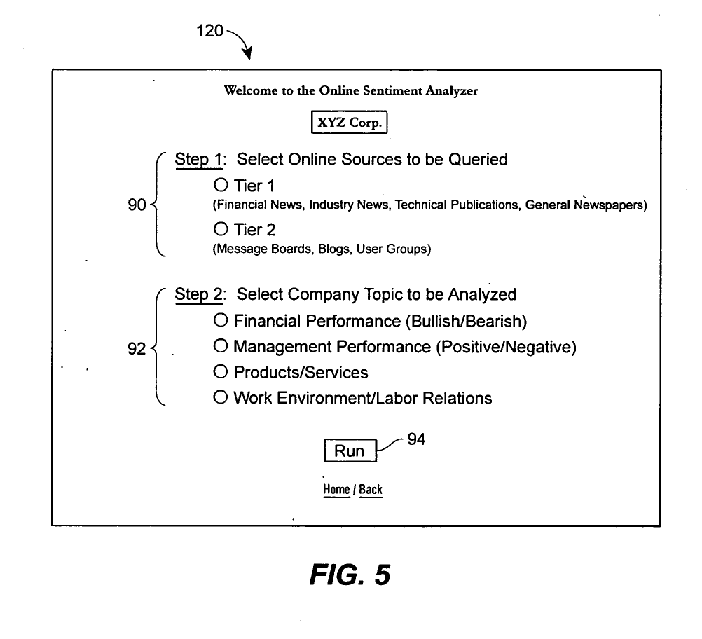

Once a specific company or symbol is identified, the financial analysis system 10 may direct the user to an input web page 120, an example of which is shown in FIG. 5. On the page 120, a source input selector section 90 allows a user to select the type(s) of online information sources, e.g., Tier 1 and/or Tier 2 sources 52 and 54 to be queried. The user may select one or both of the types of sources for searching. Additionally, an output selector section 92 allows a user to select those company characteristics, features or categories on which the sentiment data will be analyzed. Additional configurations may be used to allow the user to select a variety of input sources and categories for analysis. After selecting the company or security (FIG. 4), the type of sources to search (90) and the category or categories of data on which to perform the analysis (92), the user may select the run button 94 to cause the content mining search agent 32 and the sentiment analyzer 28 to perform the data source searching and sentiment analysis operations described above and to then plot or display the results of the search and analysis.

FIG. 6 illustrates an example graphical output 109 charting the sentiment analysis results for a single category (financial performance) retrieved from one subset of data sources (Tier 1) relating to a single security (XYZ Corporation) over a particular period of time (September through November). In this example, the horizontal axis identifies the date at which the sentiment analysis was performed, while the vertical axis indicates the numerical value (or some scaled version thereof) assigned to the sentiment analysis. A line 110 charts the sentiment analysis value obtained by analyzing data from the Tier 1 sources 52. In an embodiment in which this graphical output is displayed on a web page, the web page may contain navigational buttons. In FIG. 6, buttons identified as “Home” 121, “Back” 122, and “Input” 124 allow a user to direct new queries. In particular, the “Home” button 121, when selected, returns the user to the home web page depicted in FIG. 4 The “Back” button 122 returns the user to the last web page viewed by the user. The “Input” button 124 returns the user to the input selection web page depicted in FIG. 5.

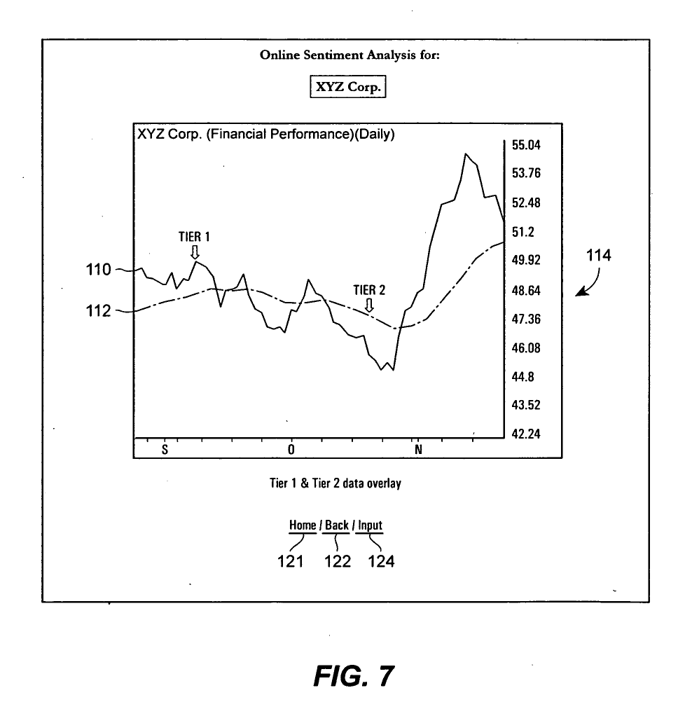

FIG. 7 illustrates a graphical output 114 charting the sentiment analysis results for a single category of data (financial performance) retrieved from two subsets of data sources (Tier 1 and Tier 2) relating to a single security (XYZ Corporation) over a period of time. The display 114 of FIG. 7 is similar to the display 109 of FIG. 6, except that the display 114 of FIG. 7 also includes an additional line 112 charting the sentiment analysis value obtained by analyzing data from Tier 2 sources 54 for the specific security (XYZ Corporation) over the same time as that depicted for Tier 1 sources.

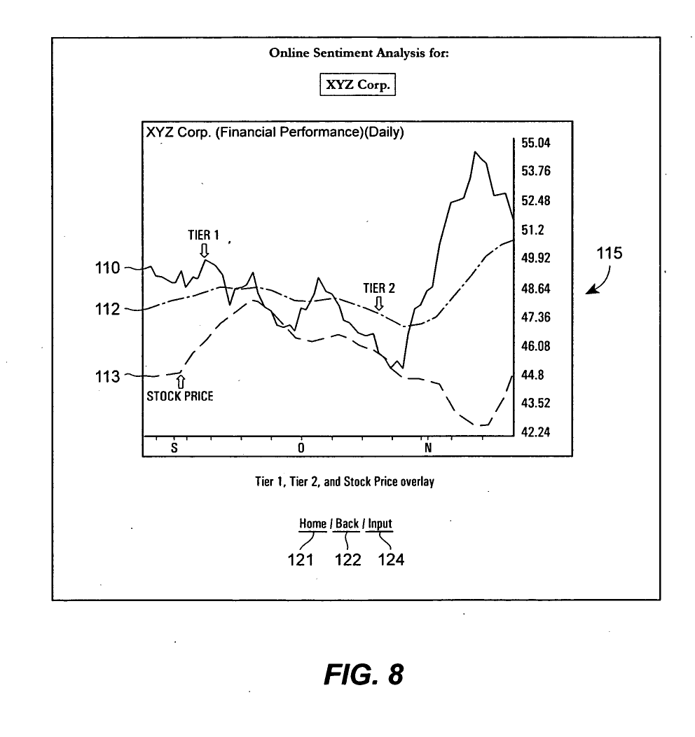

FIG. 8 illustrates a graphical output 115 charting the sentiment analysis results for a single category (i.e., financial performance) retrieved from two subsets of data. sources (Tier 1 and Tier 2) 52 and 54 relating to a single security over a period of time compared to the stock price for the security over the same period of time, all of which are plotted on a daily basis. The display 115 of FIG. 8 is similar to the display 114 of FIG. 7, except that the display 115 of FIG. 8 also includes an additional line 113 charting the stock market price for the selected security over the same period of time.

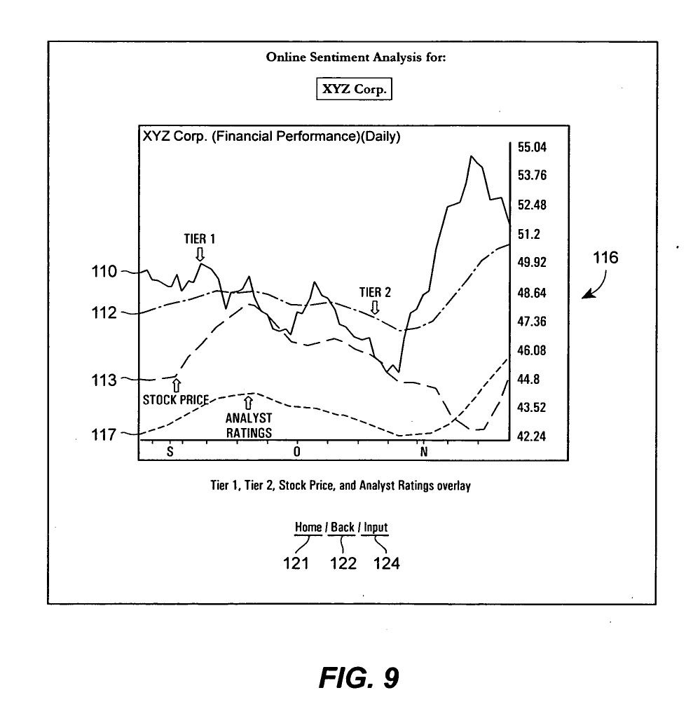

FIG. 9 illustrates a graphical output 116 charting the sentiment analysis results for a single category retrieved from two subsets of data sources relating to a single security over a period of time compared to the stock price and to analyst ratings for the security over the same period of time. The display 116 of FIG. 9 is similar to the display 115 of FIG. 8, except that the display 116 of FIG. 9 also includes an additional line 117 charting the consensus of Wall Street analyst reports for the selected security over the same period of time. Such analyst reports are available from sources including First Call™ which may be obtained by the analysis system 10 via the Internet or any other communication connection.

Of course, FIGS. 6-9 merely demonstrate a couple of possible graphical outputs that may be generated by the system 10. Numerous combinations of input data and user selections can result in a variety of different graphical outputs illustrating other data. For example, a user could choose to plot sentiment analysis for multiple stocks, including lines corresponding to any combination of the sentiment analysis results from each data source, for multiple categories, historical stock prices, and analyst reports for each stock. Similarly, a user could choose a graphical output containing lines corresponding to the sentiment analysis for multiple different categories relating to a single financial entity. If desired, a graphical output could contain combined sentiment analysis values for multiple categories, using an average, a weighted average, or some other formula devised by the user or operator, either for a single financial entity or for multiple entities. The graphical output could include such averaging or weighting applied to the data sources to create a new sentiment analysis value for one or more financial entities or categories. Additionally, outside data, including historical stock pricing and analyst reports could also be included in any such averaging or formulas if so desired. The user interface program may also use some other pictorial representation or method of organization to display the data.

In another embodiment, the user may be given an opportunity to define the topic of sentiment analysis to be performed. Here, the user's request may connect directly to the program controlling the sentiment analysis and in this embodiment, the user's request will retrieve real-time sentiment analysis, rather than historical data obtained from the database archive. The output of this real-time analysis may be expressed in a numerical result of the sentiment analyzer 28 or through opinion quotes obtained from the data sources searched. Selected raw text may be stored in the database archive, if preferred.

Still further, it will be understood from the discussion above that the search for data sources and the performance of sentiment analysis on identified text within the data sources may be performed at the time that a user initiates a query or a request, or may be performed automatically and periodically in response to a set of search parameters stored in the database 34 at some earlier time. Likewise, any combination of the results of a search for data sources, the value assigned by the sentiment analyzer on any particular search result for any particular category and/or type of data source, the date on which the search and/or analysis was performed, the text on which the analysis was performed and an identification of the source or the type of source containing the analyzed text can be stored in the database 34. Likewise, if raw data or data source identifiers are stored in the database 34, the sentiment analyzer may, in response to a particular query by a user, operate only on data or text stored within or referred to by data source identifiers within the database 34, may operate on data obtained by a current search or both.

Still further, the sentiment analyzer 28 may assign any desired type of value or identifier to a set of data or text to express the sentiment within that data or text. For example, the sentiment analyzer 28 may assign a simple identifier merely indicating whether the sentiment within the data or text was positive or negative. In other embodiments, the sentiment analyzer 28 may assign a numerical or other type of value to the sentiment expressing a level of sentiment, e.g., a value that indicates a relative level or strength associated with a positive or a negative sentiment. The range that this value may take may be continuous or discrete, e.g., one of a number of preset or predefined levels. If desired, the value determined by the sentiment analysis may be normalized in some manner with, for example, stock market prices, sentiment values for other products or securities, sentiment values for other categories associated with the same product or security, averages, means, medians of these values, etc.

Thus, while the present invention has been described with reference to specific embodiments, which are intended to be illustrative only and not limiting of the invention, it will be apparent to those of ordinary skill in the art that changes, additions and/or deletions may be made to the disclosed embodiments without departing from the spirit and scope of the invention.

1. A computer system for performing financial analysis using raw textual data stored in one or more electronic data sources, comprising:
a computer readable memory;
a content mining search agent stored on the computer readable memory and adapted to be executed on a processor to search for raw textual data in the one or more electronic data sources using natural language processing to identify relevant raw textual data within the one or more electronic data sources related to a particular financial entity;
a sentiment analyzer stored on the computer readable memory and adapted to be executed on a processor to determine a nature of sentiment with respect to the financial entity in the relevant raw textual data identified by the content mining search agent and to assign a value to the nature of the sentiment in the relevant raw textual data; and
a user interface program stored on the computer readable memory and adapted to be executed on a processor to control the content mining search agent and the sentiment analyzer and to display the value of the nature of the sentiment with respect to the financial entity assigned by the sentiment analyzer.

2. The computer system of claim 1, wherein the sentiment analyzer detects a strength of the sentiment in the relevant raw textual data identified by the content mining search agent and assigns a value to the strength of the sentiment in the relevant raw textual data.

3. The computer system of claim 2, wherein the value assigned to the strength of the sentiment of the relevant raw textual data is numerical.

4. The computer system of claim 1, wherein the user interface program, the sentiment analyzer, and the content mining search agent are connected via a common communication network.

5. The computer system of claim 1, further including an archive database that stores the value of the nature of the sentiment with respect to the financial entity assigned by the sentiment analyzer.

6. The computer system of claim 1, wherein the content mining search agent conducts automatic and periodic queries for a pre-selected financial entity to determine relevant raw textual data related to the pre-selected financial entity, wherein the sentiment analyzer analyzes the relevant raw textual data related to the pre-selected financial entity determined by the automatic and periodic queries to determine a value of the nature of the sentiment within the relevant raw textual data related to the pre-selected financial entity and stores the value of the nature of the sentiment within the relevant raw textual data related to the pre-selected financial entity for each of the automatic and periodic queries.

7. The computer system of claim 1, wherein the content mining search agent conducts multiple queries for a pre-selected financial entity to determine relevant raw textual data related to the pre-selected financial entity, wherein the sentiment analyzer analyzes the relevant raw textual data related to the pre-selected financial entity determined in each of the multiple queries to determine a value of the nature of the sentiment within the relevant raw textual data related to the pre-selected financial entity for each of the multiple queries and stores the value of the nature of the sentiment within the relevant raw textual data related to the pre-selected financial entity for each of the multiple queries.

8. The computer system of claim 1, wherein the content mining search agent conducts automatic and periodic queries for one or more pre-selected categories related to a financial entity to determine relevant raw textual data related to the one or more categories of the pre-selected financial entity, wherein the sentiment analyzer analyzes the relevant raw textual data related to the one or more categories of the pre-selected financial entity determined by the automatic and periodic queries to determine a value of the nature of the sentiment within the relevant raw textual data related to the one or more categories of the pre-selected financial entity and stores the value of the nature of the sentiment within the relevant raw textual data related to each of the one or more categories of the pre-selected financial entity for each of the automatic and periodic queries.

9. The computer system of claim 1, wherein the content mining search agent conducts multiple queries for one or more pre-selected categories related to a financial entity to determine relevant raw textual data related to the one or more categories of the pre-selected financial entity, wherein the sentiment analyzer analyzes the relevant raw textual data related to the one or more categories of the pre-selected financial entity determined by the multiple queries to determine a value of the nature of the sentiment within the relevant raw textual data related to the one or more categories of the pre-selected financial entity and stores the value of the nature of the sentiment within the relevant raw textual data related to each of the one or more categories of the pre-selected financial entity for each of the multiple queries.

10. The computer system of claim 9, wherein the user interface program graphically displays the value of the nature of the sentiment assigned by the sentiment analyzer to one of the one or more pre-selected categories related to the financial entity for each of a plurality of times.

11. The computer system of claim 10, wherein the user interface program graphically displays financial data related to the financial entity obtained from one or more other data sources at each of the plurality of times.

12. The computer system of claim 9, wherein the user interface program graphically displays the value of the nature of the sentiment assigned by the sentiment analyzer to multiple ones of the one or more pre-selected sub-categories related to the financial entity for each of a plurality of times.

13. The computer system of claim 1, wherein the financial entity is a corporation or a security or a financial product.

14. A method for analyzing electronically stored textual data comprising:
identifying one or more sources of electronically stored textual data to be reviewed;
searching raw textual data within the one or more sources for relevant textual data related to a financial entity to identify relevant raw textual data within the one or more sources;
automatically detecting a nature of a sentiment expressed about the financial entity in the relevant raw textual data; and
assigning a value to the nature of the sentiment expressed in the relevant raw textual data.

15. The method of claim 14, wherein automatically detecting a nature of a sentiment includes automatically detecting a strength of the sentiment expressed in the relevant raw textual data and wherein assigning a value to the nature of the sentiment includes assigning a value expressing the strength of the sentiment expressed in the relevant raw textual data.

16. The method of claim 15, further including categorizing the raw textual data within the one or more sources into one or more pre-selected categories.

17. The method of claim 16, further including repeatedly searching raw textual data within the one or more sources for relevant textual data related to the financial entity at different times;
categorizing the relevant textual data into one or more categories;
detecting the strength of sentiment expressed in the relevant raw textual data for each of the one or more categories;
assigning a value to the strength of the sentiment expressed in the relevant raw textual data for each of the one or more categories at the different times; and
storing the assigned values for the strength of the sentiment expressed in the relevant raw textual data for each of the one or more categories at the different times.

18. The method of claim 17, further including storing an identifier indicating a date or a time associated with the relevant raw textual data.

19. The method of claim 18, further including graphically displaying the assigned values for the strength of the sentiment expressed in the relevant raw textual data at the different times for at least one of the one or more categories.

20. The method of claim 17, wherein the at least one of the one or more categories is related to the financial performance of the financial entity or the management performance of the financial entity or the products of the financial entity or the work environment of the financial entity.

21. The method of claim 16, further including allowing a user to select one or more of the one of more categories related to the financial entity for which relevant raw textual data will be retrieved and analyzed.

22. The method of claim 14, further including separating the data sources into subsets of data sources.

23. The method of claim 22, further including allowing a user to select a subset of sources from which relevant raw textual data will be retrieved.

24. The method of claim 14, further including allowing a user to select the financial entity for which relevant raw textual data will be retrieved and analyzed.

25. The method of claim 14, further including graphically displaying assigned values of the nature of the sentiment expressed in the relevant raw textual data at various times, and allowing the user to select publicly available financial information for the financial entity to be graphically displayed with the assigned values of the nature of the sentiment express in the relevant raw textual data at various times.

26. The method of claim 25, wherein the publicly available financial information includes stock prices or analyst ratings related to the financial entity.

27. The method of claim 14, further including storing one or more search parameters used by the content mining search agent to identify the relevant raw textual data.

28. The method of claim 14, further including storing one or more category defining parameters used by the sentiment analyzer to categorize relevant raw textual data into one or more categories.

29. A user interface system for interfacing between a user and a sentiment analyzer, comprising:
a computer readable medium;
a user interface device; and
a user interface program stored on the computer readable medium and adapted to be executed on a processor to display, on the user interface device, one or more sentiment analysis values generated by the sentiment analyzer based on raw textual data related to a legal entity, wherein the raw textual data has been obtained from an electronic data source.

30. The user interface system of claim 29, wherein the legal entity is a corporation or a company or a partnership.

31. The user interface system of claim 29, wherein the legal entity is a securities product.

32. The user interface system of claim 29, wherein the user interface program enables the user to select the legal entity to which the raw textual data on which the sentiment analyzer operates is related.

33. The user interface system of claim 29, wherein the user interface program enables the user to select one or more categories of electronic data sources from which the raw textual data is obtained.

34. The user interface system of claim 29, wherein the user interface program enables the user to select one or more categories of topics related to the legal entity about which the raw textual data on which the sentiment analyzer operates is related.

35. The user interface system of claim 34, wherein the one or more categories is related to one or more of the financial performance of the legal entity or the management performance of the legal entity or the products of the legal entity or the work environment of the legal entity.

36. The user interface system of claim 29, wherein the user interface program is further adapted to display, on the user interface device, a representation of one or more stock prices for the legal entity in addition to the one or more sentiment analysis values generated by the sentiment analyzer.

37. The user interface system of claim 29, wherein the user interface program is further adapted to display, on the user interface device, a representation of one or more analyst ratings for the legal entity in addition to the one or more sentiment analysis values generated by the sentiment analyzer.
